(19) United States
(12) Patent Application Publication
(10) Pub. No.: US 2025/0256365 A1
(43) Pub. Date: Aug. 14, 2025

(54) Welding Jack Stand and Related Devices and Methods

(71) Applicant: Mike McLaughlin, Sigourney, IA (US)

(72) Inventor: Mike McLaughlin, Sigourney, IA (US)

(21) Appl. No.: 18/436,973

(22) Filed: Feb. 8, 2024

(51) Int. Cl. B23K 37/053; F16M 11/04

(52) U.S. Cl. CPC B23K 37/053; F16M 11/046

(57) ABSTRACT

A jack stand head comprising a threaded rod; a head affixed to the threaded rod; a threaded nut in operable communication with the threaded rod; and a central housing comprising a pawl, wherein the pawl engages the threaded nut so the threaded nut rotates when the housing is rotated in one direction.

### TECHNICAL FIELD

The disclosure relates to tools and equipment, specifically bracing equipment used to secure and support workpieces during fabrication.

### BACKGROUND

Securing and supporting workpieces is a fundamental aspect of construction, fabrication, manufacturing, and various other productive industries. For small workpieces, workbenches, vices, clamps, and fabrication tables provide ample support. However, many construction projects require other solutions due to the large scale of the components involved. One example of such a project is the installation of a pipeline, often but not exclusively for conveying crude oil and its byproducts long distances. The construction of pipelines often involves welding large diameter sections of steel pipe together. Various other industries employ jack stands in addition to their use on pipelines. Heavy manufacturing of all varieties has a need to support large workpieces and adjust their height in a safe and efficient manner.

In welding workpieces together, or in numerous other large fabrication projects, jack stands are employed to support the weight of the workpieces and allow for fine adjustments in their height. The ability to adjust the height of the workpieces is vital to ensuring proper alignment of the workpieces. To allow for adjustments in height, many jack stands used a threaded rod mated to a large stop nut. The rod rests in the adjustable tube of the jack stand, with the stop nut resting on top of the jack stand, so that rotating the stop nut extends or retracts the rod. The stop nut typically has handles extending from it to allow for adjustment of the nut by hand. However, these handles can cause difficulties and frustration when several jack stands are used in combination. As often is necessary, jack stands are used in very close proximity to each other, as they need to support the ends of workpieces to be welded together. Due to this close proximity, the jack stand stop nut cannot rotate fully, as they collide with the nearby jack stand or other obstacles. The inability to fully rotate the stop nut means the height adjustment of the jack stand is limited to a very small range, essentially eliminating the ability to adjust height. To remedy this, significant effort must be made to readjust the position of the jack stands, often to a less secure position, which requires additional worker time and often additional equipment like a forklift or more jack stands. Further, readjustment of large workpieces always carries a risk of injury to workers and others nearby. As such, there is a long felt need in the art for a jack stand that allows for height adjustment regardless of the presence of nearby obstructions.

This disclosure provides a solution to that long felt need, as the disclosure relates to jack stands a related devices and methods that allow for unidirectional height adjustment with less than full rotation of the stop nut.

### BRIEF SUMMARY OF THE INVENTION

This disclosure relates to a jack stand and jack stand head capable of fully adjusting height without fully rotating its stop nut. In some implementations of this disclosure, this is accomplished through a pawl under spring tension that engages with a series of groves on the stop nut, allowing the nut to turn in one direction, while allowing the nut to remain still when force is applied in the opposite direction.

In example 1 a jack stand head comprising a threaded rod, a head affixed to the threaded rod, a threaded nut comprising a plurality of ridges, and a central housing comprising a pawl, wherein the threaded nut is in operable communication with the threaded rod.

Example 2 relates to the jack stand head of Examples 1 and 3-10, wherein the pawl engages the plurality of ridges in one direction and fails to engage the plurality of ridges in the other direction.

Example 3 relates to the jack stand head of Examples 1-2 and 4-10, wherein the pawl can be rotated to change the direction in which it engages the plurality of ridges.

Example 4 relates to the jack stand head of Examples 1-3 and 5-10, further comprising a spring housing extending from the central housing.

Example 5 relates to the jack stand head of Examples 1˜4 and 6-10, further comprising a spring within the spring housing.

Example 6 relates to the jack stand head of Examples 1-5 and 7-10, wherein the spring is compressed between the spring housing and the pawl.

Example 7 relates to the jack stand head of Examples 1-6 and 8-10, further comprising one or more handles extending from the central housing.

Example 8 relates to the jack stand head of Examples 1-7 and 9-10, wherein the spring housing is between 15 degrees and 90 degrees from one of the one or more handles.

Example 9 relates to the jack stand head of Examples 1-8 and 10, wherein the spring housing is between 30 degrees and 60 degrees from one of the one or more handles.

Example 10 relates to the jack stand head of Examples 1-9, wherein the spring housing is 52 degrees from one of the one or more handles.

In example 11, A jack stand comprising a base, a threaded rod inserted into the base, a head affixed to the threaded rod, a threaded nut in operable communication with the threaded rod, and a central housing comprising a pawl, wherein the pawl engages the threaded nut so the threaded nut rotates when the housing is rotated in one direction.

Example 12 relates to the jack stand head of Examples 11 and 13-17, wherein the base further comprises 3 or more legs connected to a central tube.

Example 13 relates to the jack stand head of Examples 11-12 and 14-17, wherein the pawl can be rotated 180 degrees.

Example 14 relates to the jack stand head of Examples 11-13 and 15-17, wherein the 180 degree rotation of the pawl changes the direction in which the pawl causes the nut to rotate.

Example 15 relates to the jack stand head of Examples 11-14 and 16-17, further comprising a spring housing extending from the central housing.

Example 16 relates to the jack stand head of Examples 11-15 and 17, further comprising a spring within the spring housing.

Example 17 relates to the jack stand head of Examples 11-16, wherein the spring is compressed between the spring housing and the pawl.

In example 18, a jack stand comprising a base comprising a central tube and 3 or more legs connected to the central tube, a threaded rod inserted into the central tube, a head affixed to the threaded rod, a threaded nut in operable communication with the threaded rod, a central housing comprising a pawl, a spring housing extending from the central housing, one or more handles extending from the central housing, wherein the pawl engages the threaded nut so the threaded nut rotates when the housing is rotated in one direction, and wherein the spring housing is between 15 degrees and 90 degrees from one of the one or more handles.

Example 19 relates to the jack stand head of Examples 18 and 20, wherein the spring housing is between 30 degrees and 60 degrees from one of the one or more handles.

Example 20 relates to the jack stand head of Examples 18 and 19, wherein the spring housing is 52 degrees from one of the one or more handles.

### BRIEF DESCRIPTION OF DRAWINGS

FIG. 1 shows a jack stand commonly used in industry.

FIG. 2A shows a side view of a jack stand handle incapable of rotation due to interference of a nearby clamp, according to one implementation.

FIG. 2B shows a view from above of a jack stand handle incapable of rotation due to interference of a nearby clamp, according to one implementation.

FIG. 2C shows another side view of a jack stand handle incapable of rotation due to interference of a nearby clamp, according to one implementation.

FIG. 2D shows a welder working on a workpiece with the jack stand handle in the way of the welder's hands.

FIG. 3A is an isometric view of the jack stand head, according to one implementation.

FIG. 3B is an isometric view of the jack stand head on its side, according to one implementation.

FIG. 4 is a diagram of the adjustment handle, according to one implementation.

FIG. 5A is a diagram of the adjustment handle, according to one implementation.

FIG. 5B is a close up of the pawl mechanism of the adjustment handle, according to one implementation.

FIG. 6 is an isometric view of the adjustment handles, according to one implementation.

### DETAILED DESCRIPTION

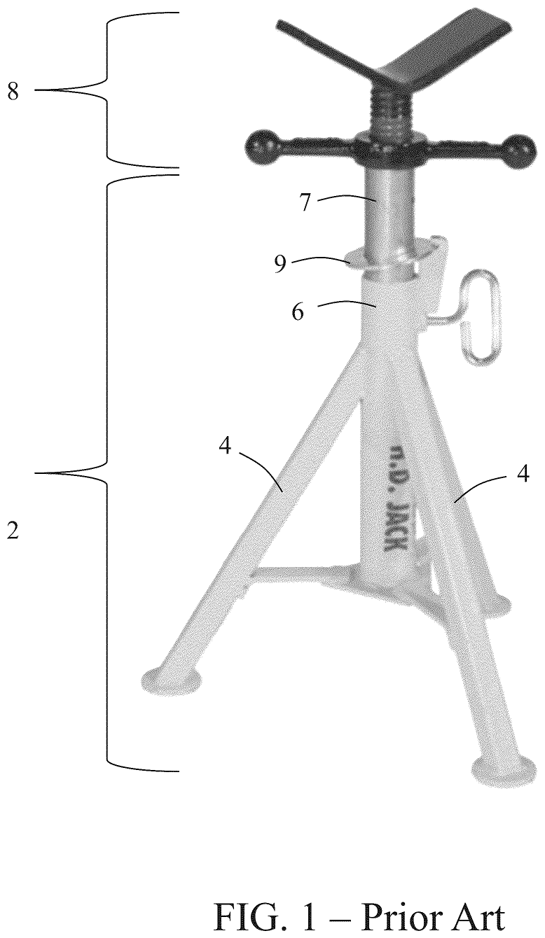

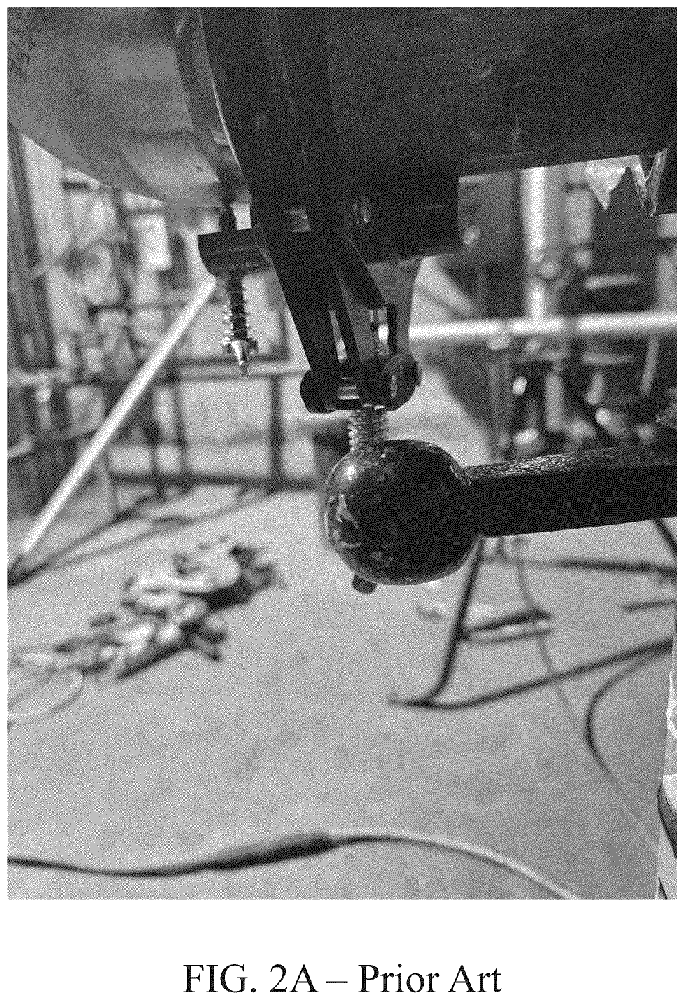

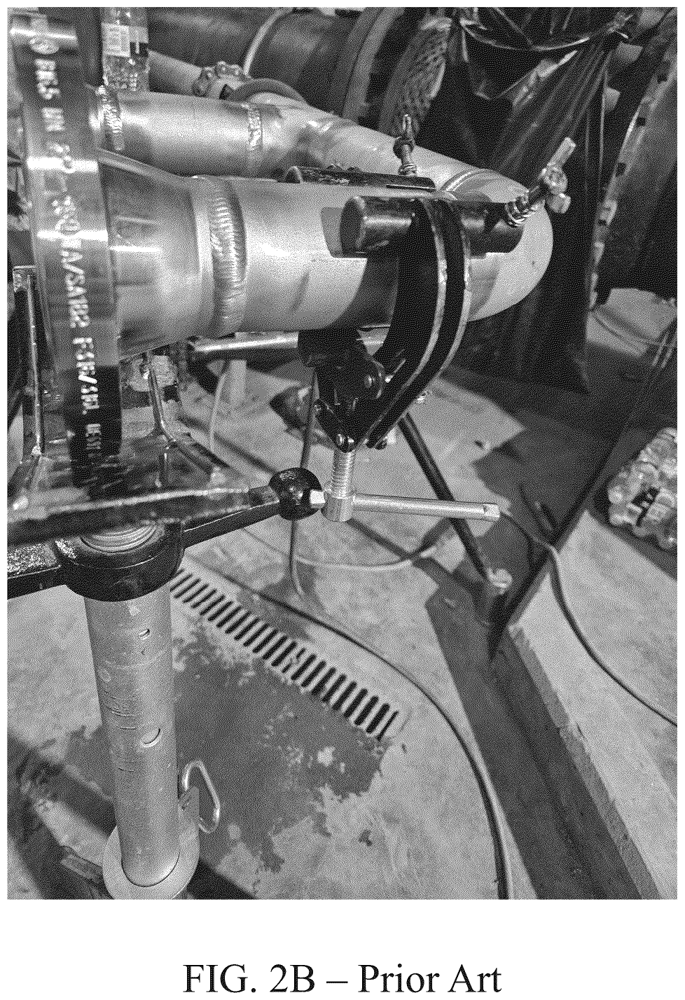

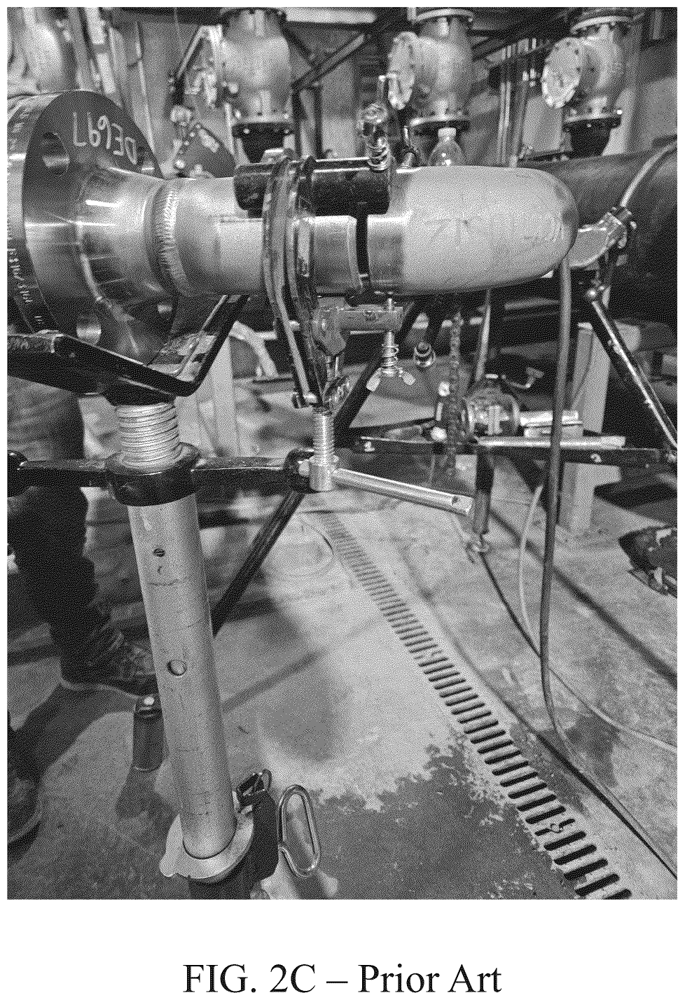

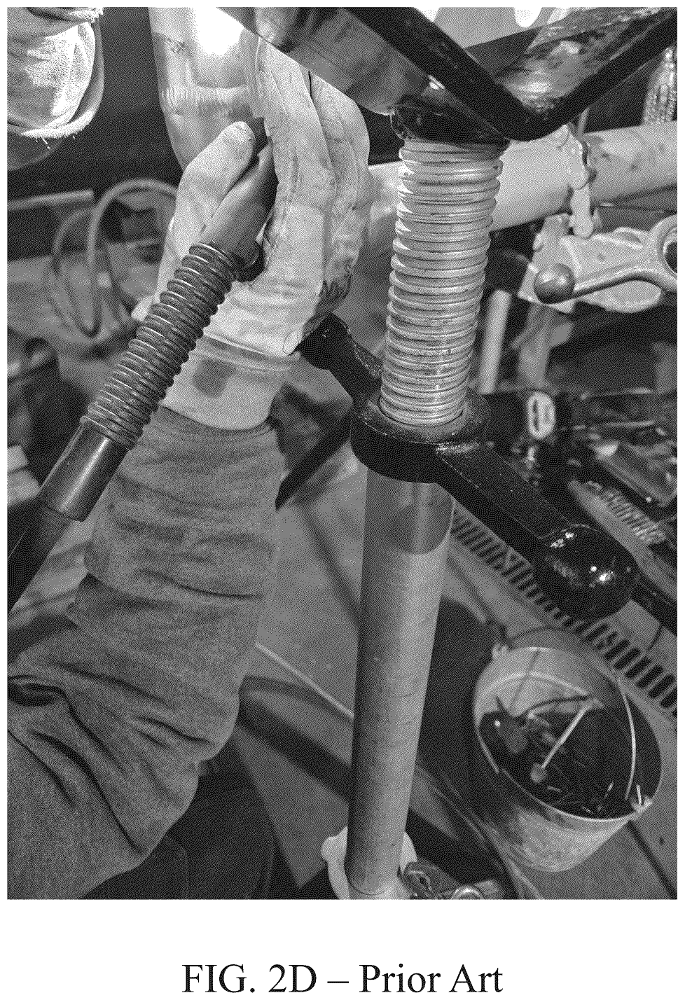

The disclosed technology relates to an adjustable jack stand, such as those used in supporting sections of pipe during the fabrication of pipelines, and related devices and methods. FIG. 1 shows an example of similar jack stands, as exist in the prior art. However, these prior jack stands have a flaw that can hinder the productivity of the welders and fabricators using the jack stands. Often, numerous of these jack stands are needed to support several workpieces, such as two or more segments of large diameter pipe to be welded together. As would be understood, the height of the heads, and therefore the supported workpieces, of these jack stands can be adjusted up and down by rotating an adjustment handle. Height adjustments often require several full rotations of the handle. Because these workpieces are often being welded or otherwise secured together, jack stands are often placed at the very ends of the workpieces to ensure the ends of the workpieces do not change position prior to or during assembly. As shown in FIGS. 2A-2C, jack stands would be placed close to the ends of two workpieces, and as these pieces are placed close together to allow for fabrication, it is often the case that the handles used for adjusting the height of the jack stands collide with nearby jack stands or other tools, such as clamps or fitting, and disallow for height adjustment. Additionally, as shown in FIG. 2D, once a handle is in the proper height position, it can be in an inconvenient position for those working on the supported workpiece, such as those welding on the workpiece. To remedy this, users of the jack stands must readjust the position of the jack stands to allow for height adjustment again, often to a less-secure position than originally used. As the workpieces on the jack stands can be very heavy and cumbersome, such as a section of large diameter pipe, the time and effort required for readjustment can be quite significant.

According to several implementations, the present disclosure remedies this issue by providing a device that allows for height adjustment of jack stands despite obstructions to the full rotations of the handles. As would be understood, and as shown in FIG. 1, a jack stand is typically made of a base 2 and a head unit 8. In various implementations, the base 2 is made up of legs 4 that support an outer tube 6. Inside the outer tube 6 is an adjustable tube held in position by a jam washer 9. As would be understood, the jam washer 9 wedges itself against the adjustable tube 7 to prevent movement of the adjustable tube 7 in relation to the outer tube 6. The jam washer 9 can be lifted slightly by a user to allow for adjustment of the adjustable tube 7. As would be understood, the adjustable tube 7 is adjusted when large changes in position are needed, while the head unit 8 is adjusted when the jack stand is loaded or when fine adjustment is needed.

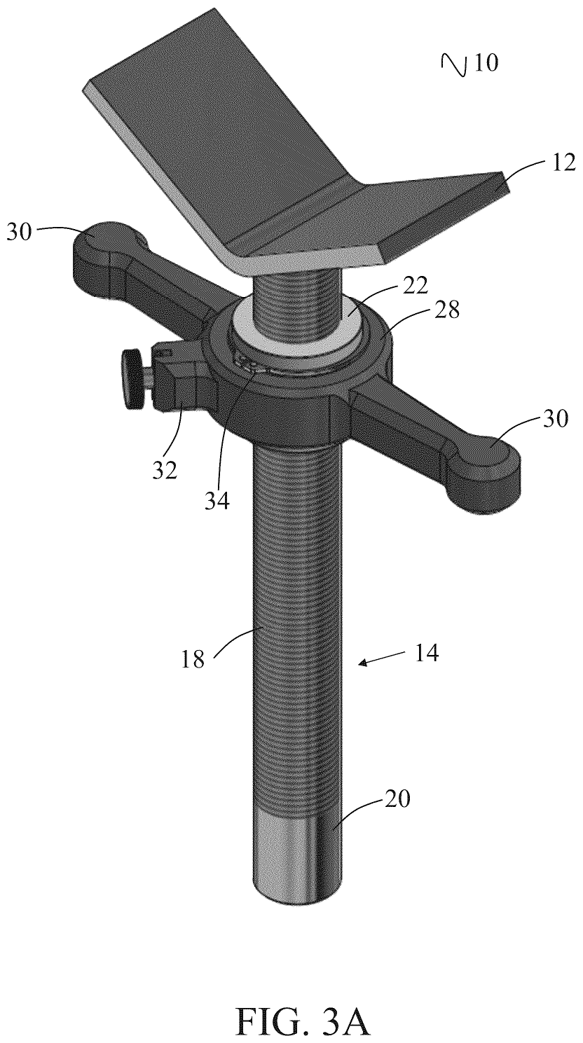

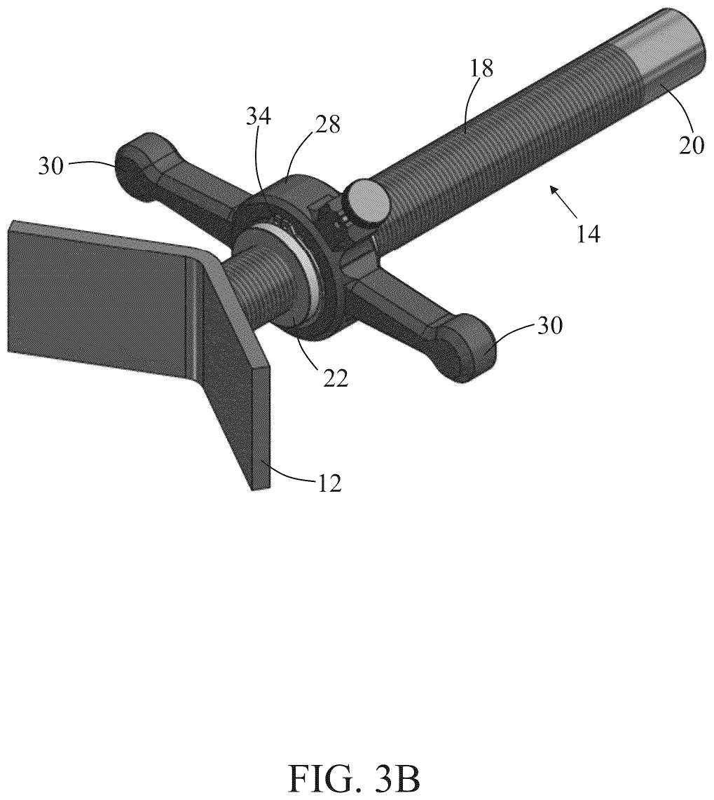

As seen in FIGS. 3A and 3B, the novel jack stand head 10 can have three major components: the head 12, the threaded rod 14, and the adjustment handle 16, along with numerous minor components. In some implementations, the head 12 is affixed to one end of the threaded rod 14, which can be an elongate cylinder with a spiral thread 18 cut into the outer surface of the threaded rod 14. The other end of threaded rod 14 can have an unthreaded portion 20 lacking any spiral thread 18 so that objects engaged in the spiral thread 18 cannot be spun off of the threaded rod 14. The head 12 can take a variety of geometries, depending on the present requirements of the tool. The head 12 can be a single roller head, double roller head, V-plate head, flat plate head, V-roller head, roller bearing head, V-roller bearing head, tool caddy head, or any other style of head that would be understood in the art. As would be understood, the jack stand head 10 can be coupled with a standard jack stand base 8 to allow the use of a full pipe jack stand.

According to various implementations, the adjustment handle 16 can have a nut 22 that can be cylindrical with a spiral thread 18 cut into its inner diameter such that the spiral thread 18 of the nut 22 can be engaged with the spiral thread 18 of the threaded rod 14. In some implementations, the spiral thread 18 of both the threaded rod 14 and nut 22 can be a 1½ inch Acme thread. Of course, other thread diameters and thread styles would be possible without stepping outside the scope of this disclosure. As would be understood, the load capacity of the jack stand head 10 can be adjusted by varying the height of the nut 22. As the nut 22 increases in height, more of the spiral threads 18 are in contact between the nut 22 and threaded rod 14, leading to more friction and higher weight bearing capabilities.

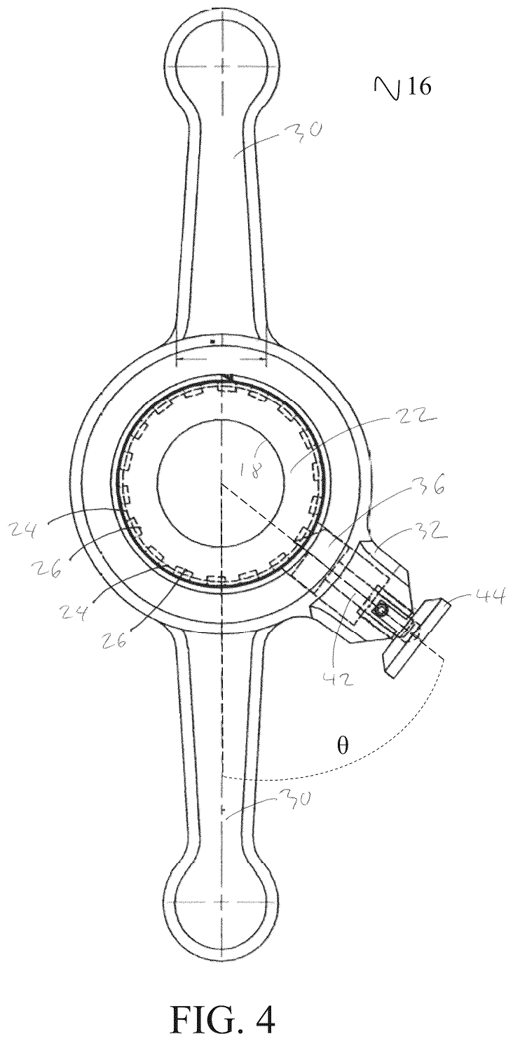

Turning now to FIG. 4, the nut 22, in some implementations, can have a plurality of ridges 24 and depressions 26 in its outer diameter. These ridges 24 and depressions 26 run parallel to each other and optionally run about axially to the nut 22. The ridges 24 and depressions 26 can always run at some angle away from the axial direction, as would be understood. The ridges 24 and depressions 26 can run the full height of the nut 22 or only a portion of the height of the nut 22, as would be understood.

Turning back to FIGS. 3A and 3B, the adjustment handle 16, in some implementations, can have a central housing 28 disposed around the nut 22. Extending from the central housing 28 can be one or more arms 30. Also extending from the central housing 28 is a spring housing 32. The central housing 28 can be held in place on the nut 22 by one or more retaining rings 34, which are secured into complementary grooves in the nut 22. Of course, other methods of securing the central housing 28 onto the nut 22 are possible, as would be understood in the art.

Shown in FIG. 4, in some implementations, the spring housing 32 can be at some angle θ as measured from the centerline of one of the arms 30 and the centerline of the spring housing 32. In various implementations, the angle θ can be between about 15 degrees and about 90 degrees. In other implementations, the angle θ can be between about 30 and about 60 degrees. In one implementation, the angle θ can be about 52 degrees. As would be understood, adjustments to the angle θ would be done to optimize the ergonomics of the adjustment handle 16, and various angles θ could be selected, depending on the specifics of the implementation.

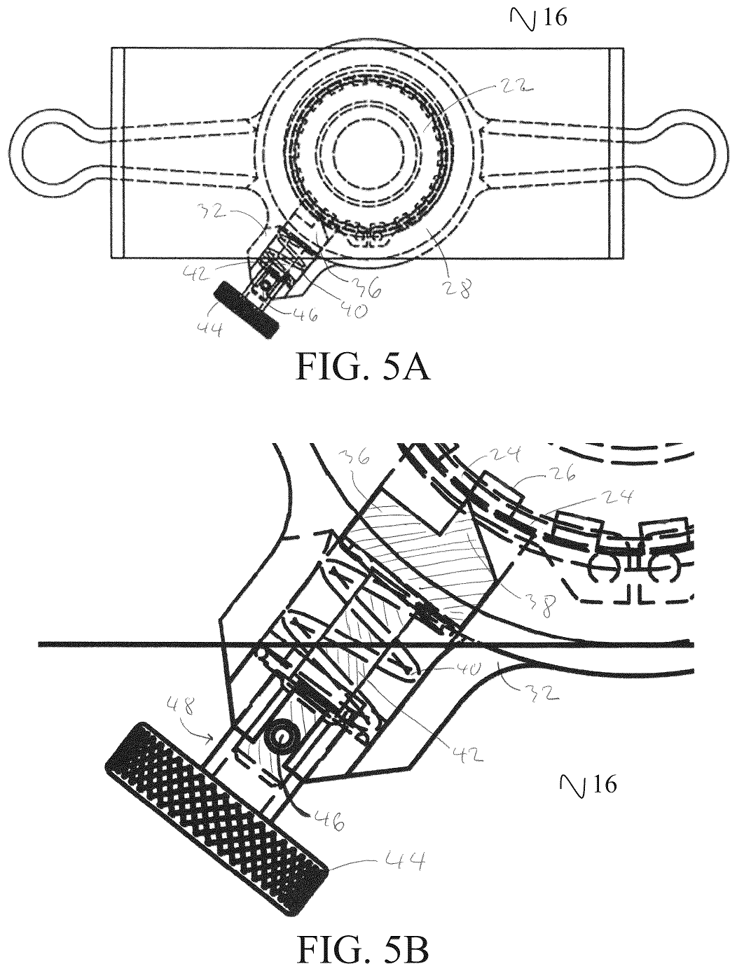

Shown in FIGS. 4, 5A, and 5B, according to some implementations, within the central housing 28 and spring housing 32 is a pawl 36 that is generally cylindrical with a tooth 38 on the end that faces the center of the central housing 28. Also within the spring housing 32 is a spring 40, which is compressed between the pawl 36 and interior of the spring housing 32 so that the pawl 36 is pressed into the nut 22. The tooth 38 at the end of the pawl 36 has a flat edge and a slanted edge, such that the flat edge engages with the ridges 24 of the nut 22 and prevents rotation in one direction, while the slanted edge allows for the gradual depression of the spring 40 by the ridges 24 which prevents engagement and allows rotation in the other direction.

According to some implementations, the pawl 36 is connected to a shaft 42 that extends out of the spring housing 32. At the end of the shaft 42 opposite of the pawl 36 can be a knob 44. Protruding radially from the shaft 42 is a roll pin 46. The roll pin 46 is positioned to nest in a groove 48 in the spring housing 32. The roll pin 46 extends in only one direction from the shaft 42, while the groove 48 extends the full width of the spring housing 32. Because of this arrangement, as would be understood, a user could pull on the knob 44, which would pull the roll pin 46 out of the groove 48 and rotate the knob about 180 degrees before releasing the knob 44, where the roll pin 46 would return to the groove 48, but on the opposite side of the shaft 42. As would be understood, this change in orientation of the knob 44 and roll pin 46 would correspond to a change in the orientation of the pawl 36 and tooth 38. This change in pawl 36 and tooth 38 orientation would, as would be understood, corresponds to the reversal of which direction of rotation the tooth 38 allows and disallows.

As would be understood, in various implementations, rotating the nut 22 relative to the threaded rod 14 will cause the threaded rod 14 to move axially in relation to the nut 22, due to the meshed spiral thread 18 of both components. In various implementations, the nut 22 rests upon the adjustable tube 7, so that as the nut 22 and threaded rod 14 move relative to one another, the threaded rod 14 moves either up or down, depending on the direction of rotation.

As would also be understood, in various implementations, the nut 22 is rotated by applying force to the arms 30, which transmit that force through the central housing 28, into the spring housing 32, into the pawl 36, and then into the ridges 24 affixed to the nut 22. Due to the structure described above, a force to the arms 30 in the opposite direction would not transmit force to the nut 22 but would instead rotate the arms 30 and central housing 28 relative to the nut 22. As would be understood, this configuration allows for the following sequence of operations, which yields improvements over prior methods. First, the nut 22 can be rotated in one direction relative to the threaded rod 14 by a force in the same direction on the arms 30. This will either raise or lower the threaded rod 14. Then, a force in the opposite direction can be applied to the arms 30, which will rotate the arms 30 back to their starting position while leaving the nut 22 in the rotated position. Next, a force in the original direction can be applied to the arms 30 again, which will progress the nut 22 further in the original direction while allowing the arms 30 to only rotate in a specific range. This ability is very useful for actuating the threaded rod 15 fully, even when there is an obstruction near the pipe jack stand that would normally hinder the rotation of the arms 30, and therefore hinder the actuation of the threaded rod 15.

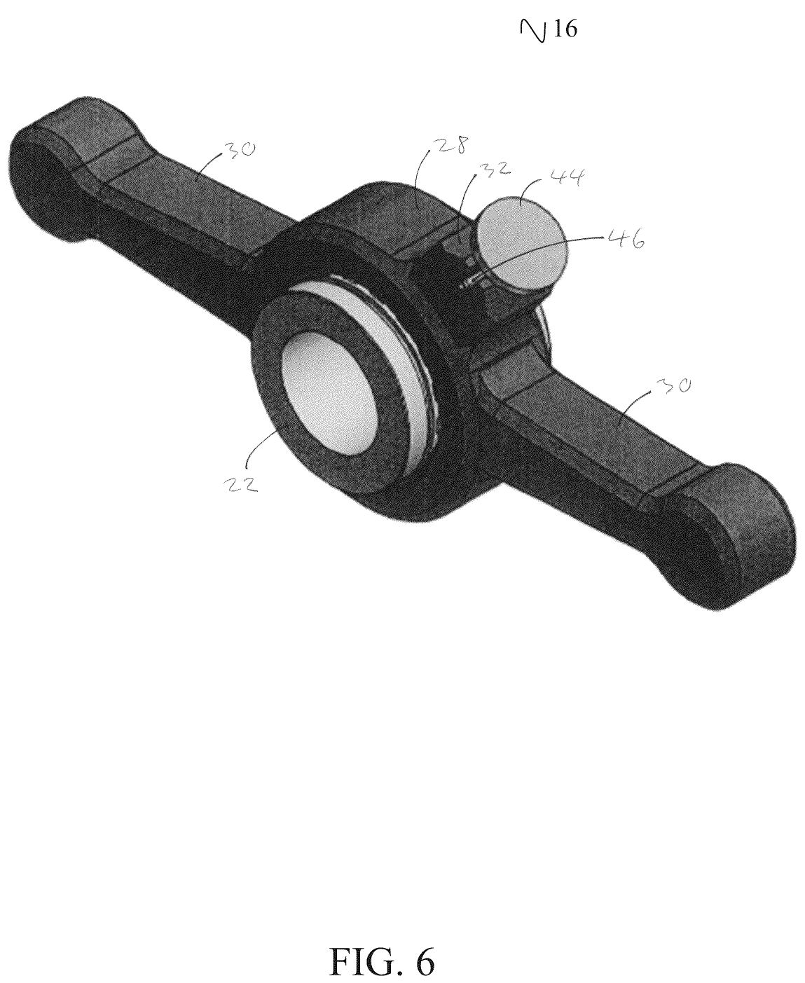

FIG. 6 shows the adjustment handle 16 uncoupled from the threaded rod 14, according to one implementation.

As would be understood, the disclosed device, according to various implementations, can be used in combination with a standard pipe jack stand base, such as shown in FIG. 1, with no modification needed. The standard pipe stand stands often have their heads replaced due to wear. Various implementations of the jack stand head 10 could be substituted in place of a replacement head unit 8.

As would also be understood, the size of the various implementations of the jack stand head 10 disclosed can be similar to the head units 8 in the marketplace. As such, the advantages of the implementations disclosed can be utilized without requiring significantly more cumbersome equipment.

Although the disclosure has been described with reference to some implementations, persons skilled in the art will recognize that changes may be made in form and detail without departing from the spirit and scope of the disclosed apparatus, systems and methods.

What is claimed:

1. A jack stand head comprising:
a. a threaded rod;
b. a head affixed to the threaded rod;
c. a threaded nut comprising a plurality of ridges; and
d. a central housing comprising a pawl,
wherein the threaded nut is in operable communication with the threaded rod.

2. The jack stand head of claim 1, wherein the pawl engages the plurality of ridges in one direction and fails to engage the plurality of ridges in the other direction.

3. The jack stand head of claim 2, wherein the pawl can be rotated to change the direction in which it engages the plurality of ridges.

4. The jack stand head of claim 1, further comprising a spring housing extending from the central housing.

5. The jack stand head of claim 1, further comprising a spring within the spring housing.

6. The jack stand head of claim 5, wherein the spring is compressed between the spring housing and the pawl.

7. The jack stand head of claim 4, further comprising one or more handles extending from the central housing.

8. The jack stand head of claim 7, wherein the spring housing is between about 15 degrees and about 90 degrees from one of the one or more handles.

9. The jack stand head of claim 7, wherein the spring housing is between about 30 degrees and about 60 degrees from one of the one or more handles.

10. The jack stand head of claim 7, wherein the spring housing is about 52 degrees from one of the one or more handles.

11. A jack stand comprising:
a. a base;
b. a threaded rod inserted into the base;
c. a head affixed to the threaded rod;
d. a threaded nut in operable communication with the threaded rod; and
e. a central housing comprising a pawl,
wherein the pawl engages the threaded nut so the threaded nut rotates when the housing is rotated in one direction.

12. The jack stand of claim 11, wherein the base further comprises 3 or more legs connected to a central tube.

13. The jack stand of claim 11, wherein the pawl can be rotated about 180 degrees.

14. The jack stand of claim 13, wherein the about 180 degree rotation of the pawl changes the direction in which the pawl causes the nut to rotate.

15. The jack stand of claim 11, further comprising a spring housing extending from the central housing.

16. The jack stand head of claim 15, further comprising a spring within the spring housing.

17. The jack stand head of claim 16, wherein the spring is compressed between the spring housing and the pawl.

18. A jack stand comprising:
a. a base comprising:
i. a central tube; and
i. 3 or more legs connected to the central tube;
b. a threaded rod inserted into the central tube;
c. a head affixed to the threaded rod;
d. a threaded nut in operable communication with the threaded rod;
e. a central housing comprising a pawl;
f. a spring housing extending from the central housing; and
g. one or more handles extending from the central housing,
wherein the pawl engages the threaded nut so the threaded nut rotates when the housing is rotated in one direction, and
wherein the spring housing is between about 15 degrees and about 90 degrees from one of the one or more handles.

19. The jack stand of claim 18, wherein the spring housing is between about 30 degrees and about 60 degrees from one of the one or more handles.

20. The jack stand of claim 18, wherein the spring housing is about 52 degrees from one of the one or more handles.
